(19) United States
(12) Patent Application Publication
(10) Pub. No.: US 2009/0151369 A1
(43) Pub. Date: Jun. 18, 2009

(54) MALFUNCTION DETECTION FOR FAN OR PUMP REFRIGERANT SYSTEM

(76) Inventors: Alexander Lifson, Manlius, NY (US); Michael F. Taras, Fayetteville, NY (US)

Correspondence Address: CARLSON, GASKEY & OLDS, P.C., 400 WEST MAPLE ROAD, SUITE 350, BIRMINGHAM, MI, 48009, US

(21) Appl. No.: 12/296,291

(22) PCT Filed: Apr. 25, 2006
(86) PCT No.: PCT/US06/15362

§ 371 Date: Oct. 7, 2008

(51) Int. Cl. F25B 1/00; G05D 23/00

(52) U.S. Cl. 62/115; 62/498; 62/157

(57) ABSTRACT

A diagnostic method for testing a fan or pump assembly in a refrigerant system includes steps of operating a controller to periodically shut down, or reduce fan or pump speed for a short period of time, while continuing to operate the refrigerant system. Changes in an operating condition such as pressure, temperature, electric current or operating speed are monitored. If expected changes do not occur, a determination can be made that a fan or pump assembly is malfunctioning.

### BACKGROUND OF THE INVENTION

This application relates to a method and control for identifying a malfunctioning fan or pump, or an associated malfunctioning drive for the fan or pump in a refrigerant system.

Refrigerant systems are known, and are utilized in various air conditioning and refrigeration applications for heating, cooling, humidifying and dehumidifying a secondary fluid such as air. Typically, fans drive this air, over a pair of heat exchangers in an air-coupled refrigerant system. Analogously, pumps move water or brine through the water-to-refrigerant or brine-to-refrigerant heat exchangers in a water-coupled or brine-coupled refrigerant system. Hereafter, the references in the text will be made with respect to the fans of the refrigerant systems, with the understanding that similar conclusions can be devised regarding the pumps for secondary fluids. That is, a “fluid moving device” as used in this application refers to a fan or a pump.

As known, a compressor typically compresses a refrigerant and delivers that refrigerant to a condenser. A fan drives a secondary fluid, which is typically air, over the condenser. Generally, in a conventional air conditioning system, the condenser is located outdoors.

Refrigerant from the condenser is delivered to an expansion device, and then to an evaporator. Another fan drives the secondary fluid, which is once again typically air, over the evaporator. This air is usually directed into an environment to be conditioned.

The refrigerant is returned from the evaporator to the compressor in a closed-loop manner. Other optional components and features are often included in the refrigerant system schematic but are not required for understanding the proposed concepts.

If a fan or its associated motor or drive should malfunction, then the proper amount of the secondary fluid is not driven over the condenser or evaporator. If this occurs, there can be significant damage to other system components, and in particular, to the compressor. Also, the refrigerant system will no longer deliver the expected space conditioning performance.

As an example, if a condenser fan fails and this failure is not detected, the compressor will begin to operate at substantially higher than design discharge pressures and temperatures. This can cause damage to the compressor. Similarly, an evaporator fan malfunctioning can cause undesirably low compressor suction pressures and refrigerant flow rates, which can also result in compressor damage. Additionally, an evaporator coil can freeze-up. Further, low refrigerant flow rates can adversely affect oil return to the compressor leading to efficiency degradation and potential compressor damage. Thus, it is desirable to obtain a simple means to detect a fan failure in a refrigerant system to prevent system or performance deterioration.

### SUMMARY OF THE INVENTION

A simple system test is provided by a method and control that is utilized to identify a fan assembly failure in a refrigerant system. This system test is preferably performed periodically, such as when the system is shut down (not operational), or with a certain frequency, such as once a day.

In a disclosed embodiment, the fan motor associated with each of the condenser and the evaporator is shut off for a short time interval. The refrigerant system continues to run, and the control determines changes in system operating conditions. As an example, with the condenser shut down, the pressure or temperature at the discharge side of the compressor should increase. If such an increase is not seen, then a determination can be made that the condenser fan had already failed.

In a similar manner, if the evaporator fan is shut down, the suction pressure of the refrigerant being delivered to the compressor should fall. Again, if no such reduction is observed, a determination can be made that the evaporator fan or the fan drive has already failed.

By also looking at the current or power draw for the fan motors, similar diagnostics can be made. As an example, if the control sends a signal to shut down a fan, and the current draw by the fan does not change, a determination can be made that there is a malfunction within the fan system typically associated with the fan or fan drive. By combining the measurements of these electrical characteristics for the fan and refrigerant pressure and/or temperature observations, a determination can be made whether the malfunction is associated with the fan system or with the obstruction to the airflow within the heat exchanger or air filters.

Further, if the fan is provided with a variable speed drive (or multi-speed motor), rather than completely shutting down the fan motor, the speed at which the fan is operating can be modified. Again, some change (similar to the changes described above) in the operating conditions would be expected.

Also, if changes in pressures and/or temperatures at certain environmental conditions are observed over time, a prognosis can be made regarding component deterioration rate and expected time to failure, such that preventive maintenance can be performed prior to extensive damage throughout the refrigerant system.

The present invention thus provides a simplified method of identifying a fan malfunction, fan drive malfunction or a malfunction in the controls for a fan.

These and other features of the present invention can be best understood from the following specification and drawings, the following of which is a brief description.

### BRIEF DESCRIPTION OF THE DRAWINGS

FIG. 1A is a schematic view of a refrigerant system incorporating the present invention.

FIG. 1B shows an optional feature.

FIG. 2 is a chart showing a properly functioning condenser fan.

FIG. 3 is a chart showing a properly functioning evaporator fan.

FIG. 4 shows a properly functioning fan wherein fan current draw is reviewed.

### DETAILED DESCRIPTION OF THE PREFERRED EMBODIMENTS

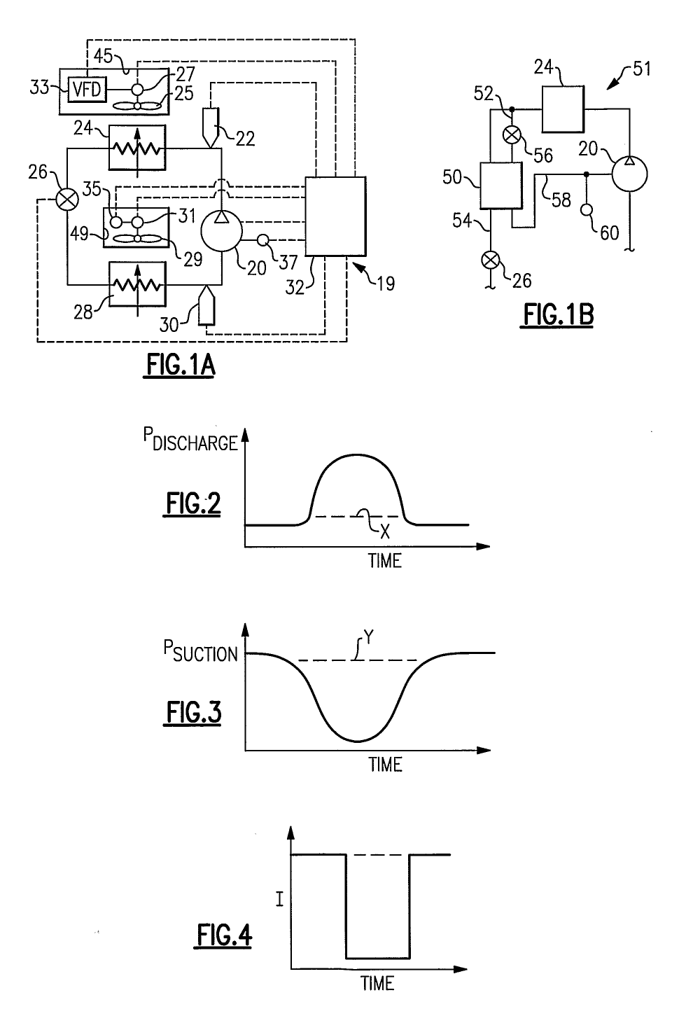

A refrigerant system 19 is illustrated in FIG. 1A. A compressor 20 delivers refrigerant downstream to a condenser 24. A discharge sensor 22 senses either the pressure or temperature on the discharge refrigerant line. Alternatively, the discharge sensor 22 can be located within the condenser 24 or between the condenser 24 and expansion device 26. Downstream of the condenser 24 is an expansion device 26. Downstream of the expansion device 26 is an evaporator 28. A suction pressure or temperature sensor 30 monitors conditions of the refrigerant flowing from the evaporator 28 back to the compressor 20.

If the system is equipped with an economizer circuit (vapor injection line), then a pressure or temperature sensor can be located at any place on this intermediate pressure line. One of the economizer circuit schematics is shown incorporated into a refrigerant system 51 in FIG. 1B. A compressor 20 delivers refrigerant to a condenser 24, and receives refrigerant from an evaporator (not shown in this figure). However, downstream of the condenser, and upstream of the main expansion device 26, a tap line 52 taps refrigerant from a liquid line 54. The tapped refrigerant in the tap line 52 passes through an auxiliary expansion device 56. That tapped refrigerant then flows through an economizer heat exchanger 50 in which it cools refrigerant in the liquid line 54 also passing through the economizer heat exchanger 50. Such economizer circuits are utilized to provide capacity and/or efficiency boost in some refrigerant systems. While the tapped refrigerant in the tap line 52 is shown flowing in the same direction, as the refrigerant the liquid line 54, through the economizer heat exchanger 50, this is only for illustration simplicity. In practice, the flows are typically arranged in a counterflow configuration. The tapped refrigerant is returned through a vapor injection line 58 to the compressor 20, and is injected into the compressor, typically at some intermediate pressure (between suction pressure and discharge pressure). A pressure or temperature sensor 60 may be located on this vapor injection line 58, and this pressures or temperature can be utilized in a similar fashion to the other pressures or temperatures that will be described below. Alternatively, the pressure or temperature sensor 60 may be located with the economizer heat exchanger 50 or between the economizer heat exchanger 50 and the auxiliary expansion device 56.

Similarly, the suction sensor 30 can be located within the evaporator 28 or between the evaporator 28 and expansion device 26. A fan assembly 45 consists of a fan 25 and a fan motor 27. A fan assembly can additionally include a variable speed drive or a multi-speed drive 33. A fan 25 is driven by a fan motor 27 to move a secondary fluid over the condenser 24. Typically, this fluid is air.

Analogously, another fan assembly 49 consists of a fan 29 and motor 31. This fan assembly can also include an optional variable speed drive or a multi-speed drive. The fan 29 is driven by a motor 31 to move air over the evaporator 28. A current, power or speed sensor 35 may be associated with both or one of the motors 27 and 31 or associated fans. Another current, power or speed sensor 37 may be associated with the compressor 20. Signals from each of the sensors are sent back to a control 32 for the refrigerant system 19.

A diagnostic method of the present invention will now be described. At some periodic time, for example late in the day when an air conditioning system may be shut down or is not in high demand, the control 32 will turn off the fan motors 27 and 31 in series for a short period of time. When this occurs, the refrigerant system 19 continues to operate, and a system conditions are monitored.

When the motor 27 is shut down for a short period of time, then an increase in the pressure or temperature above the selected tolerance threshold, sensed by the sensor 22, should be observed. As shown in FIG. 2, the discharge pressure increases with a sharp spike at the time the motor 27 is shut down. On the other hand, if the signal is relatively unchanged, such as shown at X in FIG. 2, this is an indication that the fan assembly 45 was already malfunctioning. The control 32 may then take corrective action.

The similar logic can be applied by monitoring the current or power draw of the fan motor 27. As an example, when the motor is shut down, if there is no change in the current or power draw, a determination can be made that the fan motor had already failed.

The fan 29 for the evaporator 28 can be controlled in a similar manner by shutting off the motor 31 for a short period of time. As shown in FIG. 3, with such a shut down, the suction pressure (or temperature) would be expected to fall. If, as shown at Y, the pressure is not reduced below the predetermined tolerance threshold, a determination can be made that there is a failure in the evaporator fan system 49. It should also be pointed out that the shutdown of the motor 27 would also cause a change in the reading of the sensor 30. In a similar fashion, the shutdown of the motor 31 will cause a change in the reading of the sensor 22. Therefore, a single sensor located either on the high pressure, low pressure or intermediate pressure (if economizer circuit is utilized) side of the refrigerant system 19 can be used to detect a malfunction of either condenser or evaporator fan.

FIG. 4 shows an expected change of the fan current draw. By combining the measurements of the fan electrical characteristics and refrigerant pressure or temperature observations, the determination can be made whether the malfunction is associated with the fan system or with the obstruction to the airflow within the heat exchanger or air filters. At that point, the appropriate diagnostic code can be issued and action taken.

For instance, when the control 32 monitors current drawn by the evaporator fan motor 31 along with the pressure sensor 30 feedback signal, an identification of a clogged filter associated with the evaporator 28 can be made. This would occur when the current downspike is detected by the sensor 35, but the suction pressure monitored by sensor 30 remains relatively unchanged. The motor or fan speed can also be monitored to detect a malfunctioning component. For example, if the control 32 is programmed to issue a command to shut down the fan and there is no detected change in the fan or fan motor speed or current, then the fan or the associated motor is malfunctioning.

It has to be noted that instead of pressure or temperature sensors 22 and 30, the compressor current, power draw or speed sensor 37 can be used, since the correlations exist between suction/discharge pressures and compressor current, power draw and compressor speed.

In addition, an optional variable frequency drive 33 is shown associated with the motor 27 (similarly a variable frequency drive can be associated with the motor 31). Such controls are known, and are operable to drive the motor 27 at any one of a number of speeds. By varying the speed, the method as described above, can also be performed. That is, the method can be performed without fully shutting the motor on and off, but rather simply varying the speed, observing a resultant change and comparing it to the tolerance threshold.

Also, if the changes in pressures and/or temperatures at certain environmental conditions are observed over time, a prognosis can be made regarding component deterioration rate and expected time to failure, such that preventive maintenance can be performed prior to extensive damage throughout the refrigerant system. For instance, observing pressure spike change over time may provide an indication when the air filters are due to be replaced. The present invention thus provides a simple way to monitor the operation of a fan assembly and to quickly identify if it has malfunctioned, prior to any consequent extensive damage to the refrigerant system components.

Although a preferred embodiment of this invention has been disclosed, a worker of ordinary skill in this art would recognize that certain modifications would come within the scope of this invention. For that reason, the following claims should be studied to determine the true scope and content of this invention.

1. A refrigerant system comprising:
a compressor, a condenser downstream of said compressor, an expansion device downstream of said compressor, and an evaporator downstream of said expansion device;
fluid moving device assemblies associated with both said condenser and said evaporator for moving a secondary fluid over said condenser and said evaporator; and
a control for operating the refrigerant system, said control being programmed to change a speed of operation of a motor associated with at least one of said fluid moving device assemblies for a short period of time, and said control evaluating the change in at least one system operating condition due to said speed change to determine whether said at least one fluid moving device assembly is malfunctioning.

2. The refrigerant system as set forth in claim 1, wherein said speed is programmed to be changed from a finite value to zero.

3. The refrigerant system as set forth in claim 1, wherein said speed is programmed to be changed from one non-zero value to another non-zero value.

4. The refrigerant system as set forth in claim 1, wherein said system condition is a refrigerant condition.

5. The refrigerant system as set forth in claim 1, wherein at least one system condition is selected from a set of: temperature, pressure, electric current, power draw, speed and frequency.

6. The refrigerant system as set forth in claim 1, wherein the speed of the motor associated with said fluid moving device assembly of said condenser is programmed to be changed and at least one refrigerant condition at either discharge, suction and intermediate pressure is monitored.

7. The refrigerant system as set forth in claim 1, wherein the speed of the motor associated with said fluid moving device assembly of said evaporator is programmed to be changed and at least one refrigerant condition at either discharge, suction and intermediate pressure is monitored

8. The refrigerant system as set forth in claim 1, wherein said refrigerant system includes an economized circuit.

9. The refrigerant system as set forth in claim 1, wherein a variable frequency drive is provided for at least one of said fluid moving device assemblies, and the variable frequency drive is engaged to change the operational speed of said at least one fluid moving device.

10. The refrigerant system as set forth in claim 1, wherein a multi-speed motor is provided for at least one of said fluid moving device assemblies, and the multi-speed motor is used to change the operational speed of said at least one fluid moving device.

11. The refrigerant system as set forth in claim 1, wherein said at least one fluid moving device assembly is shut off completely during the diagnostic step.

12. The refrigerant system as set forth in claim 1, wherein the changes in said at least one operating condition are monitored over time to make predictions of the health of said at least one fluid moving device assembly.

13-17. (canceled)

18. A method of operating a refrigerant system comprising:
(1) a compressor, a condenser downstream of said compressor, an expansion device downstream of said compressor, and an evaporator downstream of said expansion device;
(2) fluid moving device assemblies associated with both said condenser and said evaporator for moving a secondary fluid over said condenser and said evaporator; and
(3) a control for operating the refrigerant system, said control being programmed to change the speed of a motor associated with at least one of said fluid moving device assemblies for a short period of time, and to continue to operate the refrigerant system, said control being provided with feedback of at least one system operating condition during the change of said at least one fluid moving device assembly, and said control evaluating the feedback to determine whether said at least one fluid moving device assembly is malfunctioning.

19. The method as set forth in claim 18, wherein said system condition is a refrigerant condition.

20-21. (canceled)

22. The method as set forth in claim 19, wherein the speed of the motor of the fluid moving device assembly associated with said condenser is programmed to be changed and at least one refrigerant condition at either discharge, suction and intermediate pressure is monitored.

23. The method as set forth in claim 19, wherein the speed of the motor of the fluid moving device assembly associated with the evaporator is changed and at least one refrigerant condition at either discharge, suction and intermediate pressure is monitored.

24. The method as set forth in claim 18, wherein said speed is changed from a finite value to zero.

25. The method as set forth in claim 18, wherein said speed is changed from one non-zero value to another non-zero value.

26-27. (canceled)

28. The method as set forth in claim 18, wherein a variable frequency drive is provided for at least one of said fluid moving device assemblies, and the variable frequency drive is engaged to change the operational speed of said at least one fluid moving device.

29. (canceled)

30. The method as set forth in claim 18, wherein said at least one fluid moving device assembly is shut off completely during the diagnostic step.

31. The method as set forth in claim 18, wherein the changes in said at least one operating condition are monitored over time to make predictions of the health of said at least one fluid moving device assembly.

32-35. (canceled)
